(19) United States
(12) Patent Application Publication
(10) Pub. No.: US 2008/0166575 A1
(43) Pub. Date: Jul. 10, 2008

(54) Method For Preparing Metallic Workplaces For Cold Forming

(75) Inventors: Klaus-Dieter Nittel, Frankfurt am Main (DE); Ralf Schneider, Frankfurt am Main (DE); Andreas Lang, Nidderau (DE)

Correspondence Address: FULBRIGHT & JAWORSKI, LLP, 666 FIFTH AVE, NEW YORK, NY, 10103-3198, US

(73) Assignee: CHEMETALL GMBH, Frankfurt am Main (DE)

(21) Appl. No.: 11/913,529

(22) PCT Filed: May 3, 2006
(86) PCT No.: PCT/EP06/04121

§ 371 Date: Dec. 20, 2007

(30) Foreign Application Priority Data
May 19, 2005 (DE) 10 2005 023 023.7

(51) Int. Cl. B32B 15/04; B21B 45/02; C23C 28/00

(52) U.S. Cl. 428/457; 72/42; 205/199

(57) ABSTRACT

The invention relates to a method for preparing metallic workpieces for cold forming by contacting the metallic surfaces thereof with an aqueous acid phosphating solution so as to embody at least one phosphate coating and then coating the phosphate-coated surfaces with at least one lubricant in order to embody at least one lubricant layer. According to the inventive method, the phosphating solution essentially contains only calcium, magnesium, or/and manganese as cations that are selected among cations of main group 2 and subgroups 1, 2, and 5 to 8 of the periodic table of chemical elements in addition to phosphate. Furthermore, an alkaline earth metal-containing phosphating solution is free from fluoride and complex fluoride while the phosphating process is carried out electrolytically. The invention further relates to a metallic workpiece that is coated accordingly as well as the use of workpieces coated in said manner.

The invention concerns a process for preparing metallic workpieces for cold forming by bringing their metallic surfaces into contact with an aqueous phosphating solution to form a phosphate coating and then by coating the phosphate-coated surfaces with at least one lubricating film. It especially concerns the coating of wires, rods and other commercial forms, in particular of iron and steel raw materials for cold forming.

Phosphating processes have been in use for decades for corrosion protection, to increase the adhesion of subsequent coatings, such as e.g. a paint film, or/and to improve the cold forming process. Aqueous zinc-rich phosphating solutions are conventionally used for this purpose. In automotive construction, for example, car bodies are pretreated with very high-quality zinc-manganese-nickel phosphating treatments, which ensure very high corrosion protection and very good paint adhesion, before the paint system is applied.

Cold forming with substantially two-layer parting layer systems such as those based e.g. on phosphate and soap can be used in particular for the cold forming of strips, sheets, bosses - mainly in the form of cylindrical discs, approximately isometric bodies and short rods, wires, pipes, rods or/and complex formed component parts. It is used in particular for iron and steel materials including high-alloy steels such as e.g. special steels, but to a certain extent also for aluminium, aluminium alloys, magnesium alloys, titanium, titanium alloys, zinc and zinc alloys. These processes are also suitable in principle for other metallic materials.

Cold forming can in principle be a) slide drawing such as e.g. wire drawing or tube drawing, b) cold massive forming such as e.g. cold extrusion, cold upsetting or ironing, or c) deep drawing.

Wire drawing is carried out on wires, profiles or/and rods, made in particular from iron and steel materials, occasionally from aluminium- or titanium-rich materials. Wire drawing is used for example to draw low-carbon wires such as e.g. cold-upsetting wires or high-carbon wires such as spring wires to substantially smaller diameters and correspondingly longer lengths.

Tube drawing is used to draw tubes longitudinally, thereby reducing their diameters and wall thicknesses.

In cold extrusion, solid bodies are pressed into solid bodies having an altered geometry, wherein the lengths, wall thicknesses or diameters of the metallic components to be formed are substantially changed. Bosses can be formed into hollow bodies which can optionally be further extended lengthways and reduced in diameter by subsequent ironing. Cold extrusion is used in particular to produce small parts for gears, steering mechanisms, engines and pumps.

In cold upsetting, wires, profiles or rods are cut off to a certain length and largely or entirely given their commercial shape by upsetting. They are formed in particular into nuts, rivets or screws.

In ironing, oblong hollow bodies can be extended by a factor of commonly about 4 and reduced correspondingly in cross-section or in diameter and wall thickness. Corresponding hollow bodies can be used as cans, sleeves or pipes.

In deep drawing, the wall thickness of the metallic component to be formed remains unchanged or substantially unchanged. In deep drawing, strips are cut and the metal sections or sheets formed into cooking pans, oil trays or sinks, for example.

Cold-upsetting wire generally has carbon contents in the range from 0.05 to 0.45 wt. % and is used among other things to produce nuts, rivets or screws. It is conventionally pre-drawn and annealed. A coating based on zinc phosphate, lubricant carrier salt or calcium hydroxide is then usually applied, followed by a coating based on a metal soap. The cold-upsetting wire coated in this way is then drawn in the calibrating drawing die, bent (cut) and cold upset. Coating is generally carried out by dipping or in a continuous process through a bath. After upsetting, threads can be incorporated into the screws to be manufactured by cutting or rolling.

Lubricant carrier salts, calcium hydroxide or phosphates, based in particular on zinc phosphate, can be applied as a first layer to the surfaces of the metallic workpieces to be formed. With even slightly elevated requirements, however, these coatings additionally require a lubricant film in order to be able to use the workpieces coated in this way for cold forming.

Lubricant carrier salts are salts based on borates, carbonates or/and sulfates which contain in particular at least one compound selected from alkali or alkaline-earth borates, alkali or calcium carbonates, alkali sulfates and additives such as those based e.g. on soaps or/and thickeners. Boron compounds above all ensure certain lubricating properties.

However, lubricant carrier salts or calcium hydroxide do not satisfy the higher technical requirements for coated cold-upsetting wires. The application of zinc phosphate is then recommended. An essential prerequisite for zinc phosphating is a treatment of the waste water that is produced, in particular by precipitation e.g. as zinc hydroxide, and disposal of the sludge, which ensures that the low statutory limiting values for zinc in waste water are met. It is of no significance here whether the zinc phosphate coating is applied by a currentless method by means of a chemical reaction or electrolytically using an electrical current. If a zinc phosphate coating is deposited electrolytically onto cold-upsetting wire, this can only be done in a continuous process. A currentless deposition preferably takes place by dipping or continuously. Electrolytic phosphating has been of almost no industrial significance until now, however.

A particular property of the zinc phosphate coating is that on contact with hot aqueous solutions containing sodium stearate the zinc phosphate reacts at least partially to form zinc stearate and a water-soluble sodium phosphate, which is often at least partially washed out. This zinc stearate layer is permanently intergrown with the zinc phosphate coating and is a particularly good lubricant, which supports wire drawing and cold upsetting. A substantially three-layer coating system is often formed from the two applied coatings, which commonly displays fluid transitions from one layer to the next, wherein on top of a zinc phosphate-rich layer a layer containing predominantly zinc stearate is formed first, followed by a layer containing predominantly sodium stearate. The upper two layers can vary within wide ranges in terms of their film thicknesses. Their coating thickness ratio often varies in the ratio from 9:1 to 1:9.

Medium- to high-carbon wire, which often has a carbon content in the range from 0.5 to 1.0 wt. %, is conventionally annealed after drawing on so-called pre-drawing dies and cooled in a lead bath (known as patenting). The lead residues can be removed in a pickling bath. The wire bundle is separated into individual wire strands. After patenting, these wire strands are conventionally coated with zinc phosphate. This is carried out in a continuous process.

Zinc phosphating of such a wire can be carried out by a currentless method or electrolytically. Like any zinc phosphating process, a waste-water treatment is obligatory. There have been numerous attempts to replace the zinc phosphate coating by coatings with so-called lubricant carrier salts. Lubricant carrier salts are mixtures of borates, carbonates or/and sulfates, in particular of at least one compound selected from alkali or alkaline-earth borates, alkali or calcium carbonates, alkali sulfates and additives such as those based e.g. on soaps or thickeners. Coatings can be applied in or with aqueous solutions thereof, e.g. by dipping, wherein these coatings can then be dried or dry due to the intrinsic temperature of the hot workpieces. Apart from a few exceptions, phosphate-free mixtures have proven themselves only to a limited extent due to the restricted capacity in terms of drawing speed in wire drawing.

Due to the toxicological and ecological risks associated in particular with chromate-containing processes, but also with nickel-containing processes, alternative processes have been sought for many years now. It has nevertheless repeatedly been found that for many applications entirely chromate-free or entirely nickel-free processes do not meet 100% of the performance spectrum, or not with the desired reliability. Attempts are then made to keep the chromate or nickel contents as low as possible and to replace Cr⁶⁺ with Cr³⁺ as far as possible. In spite of many years of research and development, nickel-free phosphating for multi-metal applications such as in car bodies, where in Europe metallic surfaces of steels, galvanised steels and aluminium or aluminium alloys are typically pretreated in the same bath, has not proved successful without marked reductions in quality. However, since nickel contents, even if comparatively low, are now classed as toxicologically and ecologically more serious and hazardous than before, the question now arises as to whether an equivalent corrosion protection can be achieved with other chemical processes.

Even zinc contents are no longer regarded favourably, however, since zinc-containing waste water and sludge will in future have to be processed and disposed of at even greater cost.

The object was therefore to propose a phosphating process which as far as possible is free from heavy metals or which substantially contains only comparatively environmentally friendly metal cations. This process should be able to be used as simply and economically as possible.

The object was also to propose a coating process with inorganic salts, in particular for wire drawing and cold massive forming products, displaying the following properties:
Application from an aqueous solution or suspension,
Extensive freedom from cations which make waste water treatment necessary or which require higher costs for processing or disposal than in zinc phosphating
Better release properties for the coating system in cold forming than the previously known borate, carbonate or/and sulfate-containing lubricant carrier salts, in order to separate the die and the workpiece reliably in cold forming,
Ability of the applied phosphate coating to react at least partially on contact with a hot aqueous sodium stearate solution to form a corresponding, well-lubricating metal soap, wherein this reaction should take place in an analogous way to the reaction wherein zinc phosphate plus sodium stearate gives zinc stearate plus sodium phosphate, and
Coating properties and behaviour of the coating system in cold forming to be comparable to those of zinc phosphate coatings.

Experiments have shown that phosphates of alkaline-earth metals and of manganese have interesting lubricating and release properties. In particular, it was found that neutral and acid alkaline-earth and manganese phosphates in particular display these properties. Furthermore, it has now been determined that these phosphates or mixtures thereof can be reacted with hot aqueous sodium or/and potassium stearate solutions to form corresponding stearates with very good lubricating properties.

Commercial calcium, magnesium and manganese phosphates are relatively coarse-crystalline, water-insoluble salts. It was found that when aqueous suspensions prepared with these commercial phosphates were applied, quite rough coats dried. The coefficients of friction of these rough coats were well above those of zinc phosphate coats and they could therefore not be used for cold forming. The adhesive strength of these phosphate coats was limited, and in addition the coarser crystal components did not react at all or reacted in only a very limited way to form the corresponding metal stearate. It was found, however, that the application-oriented properties of these phosphates can be modified very positively by fine or superfine grinding: if these phosphate powders were ground to particle sizes≦30 μm, which generally corresponds to average particle sizes of <10 μm, the measured coefficients of friction of the workpieces phosphated therewith fell to close to the coefficients of friction determined with a typical zinc phosphate coating. This significantly improved the adhesive strength of the dried, fine-grain phosphate coatings and their ability to react to form the corresponding metal stearate coats.

Intensive grinding of phosphate powders is often not feasible because of the investment and processing costs for an appropriate grinding apparatus. It was also found that handling such fine powders can lead to health concerns. New ways were therefore sought to apply phosphate to metal surfaces in as finely dispersed a form as possible.

It has now been found that contrary to earlier expectations, extremely finely divided calcium, magnesium and manganese phosphate can be readily precipitated electrolytically from acid aqueous solutions and that these phosphates react well with stearate-containing solutions based on alkali metal(s) such as e.g. sodium or/and potassium to form corresponding alkaline-earth or manganese stearates.

The object is achieved with a process for preparing metallic workpieces for cold forming by bringing their metallic surfaces into contact with an aqueous acid phosphating solution to form at least one phosphate coating and then by coating the phosphate-coated surfaces with at least one lubricant to form at least one lubricating film, wherein in addition to phosphate the phosphating solution contains substantially only calcium, magnesium or/and manganese as cations chosen from cations from the 2^{nd} main group and the 1^{st}, 2^{nd} and 5^{th} to 8^{th} subgroups of the periodic table, wherein a phosphating solution containing alkaline-earth metals is free from fluoride and from complex fluoride and wherein phosphating is performed by electrolysis.

The object is also achieved with a metallic workpiece and its use in accordance with claim 27 or 28.

Before being phosphated, the metallic workpieces are commonly pickled, degreased, cleaned, rinsed, mechanically scoured e.g. by bending, ground, peeled, brushed, blasted or/and annealed.

The phosphating solution is conventionally an aqueous solution. In individual embodiments it can be a suspension, if for example it has a content of. precipitated product or/and a very fine-particle additive.

The concentrate, which is also a phosphating solution and with which the phosphating solution for the bath can be prepared, in many cases has a higher concentration of the corresponding substances than the corresponding bath composition (the bath) by a factor in the range from 1.2 to 15, often by a factor in the range from 2 to 8. The bath can be prepared from the concentrate by diluting with water and optionally also by adding at least one further additive such as e.g. NaOH or/and chlorate, which are preferably added individually only to the bath to adjust the phosphating solution.

The expression “substantially only” for the cation content relates to contents of cations other than calcium, magnesium and manganese, which do not substantially impair the further treatment and processing, although this can depend on the individual conditions. Such contents in total of all other cations should conventionally be less than 0.5 g/l, preferably less than 0.3 g/l or even less than 0.1 g/l. For example, even small contents of zinc can cause a problem if at the same time a certain chloride content, e.g. more than 100 ppm of chloride, occurs, since in some circumstances this can lead to a small content of elemental zinc in the coating, which cannot be reacted with the sodium soap and which in cold forming can then lead to corrosion of the coated substrate being formed by the die and to a fault in the production sequence which can only be rectified at considerable cost. Nickel can easily be leached out of some iron alloys, in particularly special steels. In industrial practice, contents of chromium, nickel, zinc and other heavy metals can come above all from impurities in the substrate materials, the substrate surfaces and the chemical additives that are used, from the containers and pipelines due to pickling action, from entrainment from previous process steps and from the return of recycled solutions.

Phosphating solutions according to the invention for the electrolytic deposition of calcium, magnesium or/and manganese phosphate can preferably have the following composition:

Such a phosphating solution preferably contains calcium, magnesium or/and manganese ions, phosphoric acid and optionally also at least one further inorganic or/and organic acid such as e.g. nitric acid, acetic acid or/and citric acid. The cation can in principle be incorporated with any acid forming a water-soluble salt or/and with any complexing agent. In addition to the cited inorganic acids, at least one organic monocarboxylic, dicarboxylic or/and tricarboxylic acid, at least one phosphonic acid or/and at least one of the salts and esters thereof can also be used in particular. This/these acid(s) advantageously form(s) at least one water-soluble compound with calcium, magnesium or/and manganese ions. The amount of nitric acid can be reduced as far as zero by the addition of e.g. at least one suitable carboxylic acid, since the content of calcium, magnesium or/and manganese can be coordinated in this way and dissolved in water.

The phosphating solution preferably contains 1 to 200 g/l of compounds of calcium, magnesium or/and manganese including the ions thereof, calculated as calcium, magnesium and manganese, which can be present in particular as ions, particularly preferably 2 to 150 g/l, most particularly preferably 4 to 100 g/l, in particular 6 to 70 g/l, above all 10 to 40 g/l. In many embodiments the phosphating solution contains phosphate and a) 5 to 65 g/l of Ca and 0 to 20 g/l of Mg or/and Mn or b) 5 to 50 g/l of Mg and 0 to 20 g/l of Ca or/and Mn or c) 5 to 80 g/l of Mn and 0 to 20 g/l of Ca or/and Mg. In a), b) or c) the content of the first cation can be in the range from 12 to 40 g/l in particular. The content of the second and third cation in a), b) or c) can in particular display a content of 1 to 12 g/l for the second cation and a content of 0 or 0.1 to 8 g/l for the third cation. If the content of calcium, magnesium and manganese is too low, too slight a phosphate coating or even no phosphate coating can be formed. If the content of calcium, magnesium and manganese is too high, the film quality of the phosphate coating can deteriorate. This can lead in particular to precipitations in the bath.

The phosphating solution can additionally also contain other alkaline-earth metals such as e.g. strontium or/and barium, but in particular ions of alkali metals, such as e.g. sodium, potassium or/and ammonium, above all to adjust the S value, to raise the pH and to improve the low-temperature stability. The content in the phosphating solution of alkali metals including ammonium, in particular in the form of ions, selected above all from the group comprising sodium, potassium and ammonium, is preferably in the range from 0.01 to 100 g/l, particularly preferably in the range from 0.05 to 75 g/l, most particularly preferably in the range from 0.08 to 50 g/l, in particular in the range from 0.1 to 30 g/l, above all in the range from 0.2 to 20 g/l, calculated proportionally as the particular alkali metal or as ammonium. In many embodiments the content of these compounds and ions is dependent on whether and in what amount at least one accelerator or/and at least one pH-influencing substance has been added to the phosphating solution or as a content in water or, in a recycling process, water with a content of such compounds/ions is returned to the bath.

The additives or impurities known from zinc phosphating such as e.g. nickel, cobalt or/and copper do not interfere with the coating process in the corresponding low contents, but for environmental reasons such as e.g. the necessary waste water treatment they are preferably largely or entirely avoided. The content of phosphate in the phosphating solution, calculated as PO₄, is preferably in the range from 2 to 500 g/l as PO₄, in particular as phosphate ions, particularly preferably in the range from 4 to 320 g/l, most particularly preferably in the range from 8 to 200 g/l, in particular in the range from 12 to 120 g/l, above all in the range from 20 to 80 g/l. If the content of phosphate is too low, too slight a phosphate coating or even no phosphate coating can be formed. If the content of phosphate is too high, this has no adverse affect or can reduce the film quality of the phosphate coating. Under some conditions and with too high a phosphate content the phosphate coating can then become spongily porous and precipitations in the bath can occur. The phosphate content is preferably somewhat hyperstoichiometric in comparison to the cation content.

The content of nitrate in the phosphating solution is preferably 0 or close to 0 g/l or in the range from 1 to 600 g/l, particularly as nitrate ions, particularly preferably in the range from 4 to 450 g/l, most particularly preferably in the range from 8 to 300 g/l, in particular in the range from 16 to 200 g/l, above all in the range from 30 to 120 g/l. If the phosphating solution contains little or no nitrate, it is more favourable for the waste water. A low or moderate content of nitrate can have an accelerating effect on electrolytic phosphating and can therefore be advantageous. Too low or too high a nitrate content in the phosphating solution has no substantial influence on the electrolytic phosphating process and on the quality of the phosphate coating.

The content in the phosphating solution of at least one substance selected from organic acids, the salts and esters thereof—selected in particular from monocarboxylic, dicarboxylic and tricarboxylic acids and the salts and esters thereof, such as e.g. based on citric acid, gluconic acid or/and lactic acid—and from phosphonic acids, the salts and esters thereof, selected in particular from organic phosphonic and diphosphonic acids, the salts and esters thereof, including the anions thereof, is preferably zero or close to zero or in the range from 0.1 to 200 g/l, particularly preferably in the range from 1 to 150 g/l, most particularly preferably in the range from 3 to 100 g/l, in particular in the range from 6 to 70 g/l, above all in the range from 10 to 40 g/l. They act in particular as complexing agents. Complexing agents mostly have no effect if all cations are already dissolved in water. They are necessary if a cation content in a particular composition cannot be converted by any other means into a water-soluble form. Too low or too high a complexing agent content in the phosphating solution has no substantial influence on the phosphating process and on the quality of the phosphate coating.

The entire cation content is preferably added in the form of nitrate(s) or/and other, water-soluble salts, so that an addition of complexing agent(s) is not necessary.

The phosphating solution preferably contains as accelerator at least one substance selected from substances based on chlorate, guanidine, hydroxylamine, nitrite, nitrobenzene sulfonate, perborate, peroxide, peroxysulfuric acid and other accelerators containing nitro groups. The content in the phosphating solution of accelerators other than nitrate such as e.g. based on nitrobenzene sulfonate (e.g. SNBS=sodium nibrobenzene sulfonate), chlorate, hydroxylamine, nitrite, guanidine such as e.g. nitroguanidine, perborate, peroxide, peroxysulfuric acid and other nitrogen-containing accelerators is preferably zero, close to zero or in the range from 0.1 to 100 g/l, as compounds or/and ions, calculated as the corresponding anion. The content of accelerators other than nitrate in the phosphating solution is particularly preferably in the range from 0.01 to 150 g/l, most particularly preferably in the range from 0.1 to 100 g/l, in particular in the range from 0.3 to 70 g/l, above all in the range from 0.5 to 35 g/l. The experiments showed that an addition of at least one accelerator is helpful and advantageous in many embodiments, in particular an addition of at least one nitrogen-containing accelerator. It was originally expected that the accelerators would substantially only increase the rate of film formation and would therefore have a weaker effect than in conventional currentless phosphating. It was found, however, that the accelerating effect of the accelerators including nitrate on the phosphating process in electrolytic phosphating is not usually less than in conventional currentless phosphating and that the various accelerators differ markedly in their effects on the film properties in particular.

The content of chlorate in the phosphating solution is preferably zero, close to zero or in the range from 1 to 100 g/l ClO₃⁻ ions, particularly preferably 2 to 80 g/l, most particularly preferably in the range from 3 to 60 g/l, above all in the range from 5 to 35 g/l. Chlorate can have a particularly strong accelerating effect in comparison to other accelerators and can help to form markedly finer-grain phosphate coatings.

The content of compounds based on guanidine, such as e.g. nitroguanidine, in the phosphating solution is preferably zero, close to zero or in the range from 0.1 to 10 g/l calculated as nitroguanidine, particularly preferably 0.2 to 8 g/l, most particularly preferably in the range from 0.3 to 6 g/l, above all in the range from 0.5 to 3 g/l. Relative to its content, a guanidine compound such as nitroguanidine can have a strongly accelerating effect in comparison to other accelerators and nitrate, but it gives off no oxygen and often leads to fine-grain phosphate coatings having particularly good adhesive strength.

The content of nitrobenzene sulfonate in the phosphating solution is preferably zero, close to zero or in the range from 0.1 to 10 g/l calculated as the corresponding anion, particularly preferably 0.2 to 8 g/l, most particularly preferably in the range from 0.3 to 6 g/l, above all in the range from 0.5 to 3 g/l. Relative to its content, nitrobenzene sulfonate can have a strong accelerating effect in comparison to other accelerators and often leads to fine-grain phosphate coatings having good adhesive strength.

The content of borate in the phosphating solution is preferably zero, close to zero or in the range from 0.1 to 70 g/l BO₃⁻ ions, particularly preferably 0.5 to 50 g/l, most particularly preferably in the range from 1 to 40 g/l, above all in the range from 2 to 20 g/l. Borate can have a strong accelerating effect in comparison to other accelerators and can help to form finer-grain phosphate coatings.

In some embodiments the phosphating solution is preferably free or substantially free from borate or in addition to a comparatively small borate content also has a comparatively large phosphate content.

The content of fluoride and complex fluoride in an alkaline-earth metal-containing phosphating solution is preferably zero or close to zero, since these contents often lead to precipitations. The content of fluoride or/and complex fluoride in an alkaline-earth metal-free phosphating solution is preferably in the range from 0.01 to 5 g/l, wherein these contents can bring about pickling.

The phosphating solution preferably displays the following contents:
4 to 100 g/l of Ca, Mg or/and Mn,
0 to 40 g/l of alkali metal(s) or/and NH₄,
5 to 180 g/l of PO₄,
3 to 320 g/l of nitrate or/and accelerator(s) and
0 to 80 g/l of complexing agent(s).

The phosphating solution particularly preferably displays the following contents:
5 to 60 g/l of Ca, Mg or/and Mn,
0 to 25 g/l of alkali metal(s) or/and NH₄,
8 to 100 g/l of PO₄,
5 to 240 g/l of nitrate or/and accelerator(s) and
0 to 50 g/l of complexing agent(s).

The phosphating solution most particularly preferably displays the following contents:
8 to 50 g/l of Ca, Mg or/and Mn,
0 to 20 g/l of alkali metal(s) or/and NH₄,
12 to 80 g/l of PO₄,
12 to 210 g/l of nitrate or/and accelerator(s) and
0 to 40 g/l of complexing agent(s).

In particular the phosphating solution displays the following contents:
10 to 40 g/l of Ca, Mg or/and Mn,
0 to 15 g/l of alkali metal(s) or/and NH₄,
16 to 65 g/l of PO₄,
18 to 180 g/l of nitrate or/and accelerator(s) and
0 to 32 g/l of complexing agent(s).

The pH of the phosphating solution is preferably in the range from 1 to 6, particularly preferably in the range from 1.2 to 4, often in the range from 1.5 to 3. In principle any suitable substance can be added to adjust the pH; particularly suitable are on the one hand e.g. a carbonate, an alkali solution such as NaOH or NH₄OH and on the other hand e.g. phosphoric acid or/and nitric acid. If the pH is too low, the rate of deposition in phosphating falls markedly and occasionally no phosphate at all is deposited. If the pH is too high, a spongy-porous phosphate coating can be formed, and phosphate precipitations can occur in the bath. Spongy-porous phosphate coatings are not only incompletely closed but can often also be wiped off and therefore cannot be used due to inadequate adhesive strength (=inadequate abrasion resistance).

The total acid (TA) value of a phosphating solution is preferably in the range from 20 to 200 points, particularly preferably in the range from 30 to 120 points, in particular 70 to 100 points. The Fischer total acid (TAF) value is preferably in the range from 6 to 100 points, particularly preferably in the range from 7 to 70 or 8 to 60 points, in particular 35 to 55 points. The free acid (FA) value is preferably 1 to 50 points, particularly preferably 2 to 40 points, in particular 4 to 20 points. The ratio of the free acid to the Fischer total acid value, in other words the quotient of the contents of free and bound phosphoric acid, calculated as P₂O₅, known as the S value, is preferably in the range from 0.15 to 0.6, particularly preferably in the range from 0.2 to 0.4.

An addition of e.g. at least one basic substance such as e.g. NaOH, KOH, an amine or ammonia, in particular in the form of an aqueous solution, to the phosphating solution can be used to adjust the S value.

The points value for the total acid is determined by titrating 10 ml of the phosphating solution, after dilution with water to around 50 ml, using phenolphthalein as indicator until it changes colour from colourless to red. The number of ml of 0.1 N sodium hydroxide solution consumed to this end gives the points value for the total acid. Other suitable indicators for the titration are thymolphthalein and ortho-cresolphthalein.

The points value for the free acid in a phosphating solution is determined in the corresponding way using dimethyl yellow as the indicator and titrating until the solution changes colour from pink to yellow.

The S value is defined as the ratio of free P₂O₅ to the total content of P₂O₅ and can be determined as the ratio of the points value of the free acid to the points value of the Fischer total acid. The Fischer total acid is determined using the titrated sample for titration of the free acid and adding to it 25 ml of 30% potassium oxalate solution and approximately 15 drops of phenolphthalein, setting the titrator to zero, which subtracts the points value for the free acid, and titrating until the solution changes colour from yellow to red. The number of ml of 0.1 N sodium hydroxide solution consumed to this end gives the points value for the Fischer total acid.

The temperature at which the phosphating solution is used is preferably around room temperature or in particular in the range from 10° C. to 95° C. A temperature range of 15 to 40° C. is particularly preferred. If the phosphating temperature is too high, it can often result in uneven and incompletely closed phosphate coatings. If the phosphating temperature is too low, no problems normally arise above freezing temperature.

The treatment time, in particular the time in which phosphating is performed electrolytically—in continuous processes optionally for the individual product section of a long product—is preferably 0.1 to 200 s or 1 to 180 s, particularly preferably 0.2 to 20 or 3 to 10 s, particularly for wires, or 5 to 100 s, particularly for workpieces having a larger surface area in comparison to a wire, such as for bosses or/and rods. For large workpieces, in particular for long or continuous workpieces, contact using a “bed of nails”, on which the workpiece can be supported at individual points and electrical contact made in that way, is suitable. The current intensity depends on the size of the metallic surface(s) to be coated and is commonly in the range from 50 to 5000 A, 80 to 3000 A or 100 to 1000 A for each individual wire in a continuous plant and commonly in the range from 1 to 100 A for each individual boss or rod, in other words mostly in the range from 1 to 1000 A per component.

The voltage is obtained automatically from the applied current intensity or current density. The current density—largely independently of the direct current or/and alternating current components—is preferably in the range from 0.5 to 1000, from 1 to 700 A/dm² or from 1 to 400 A/d m², particularly preferably in the range from 1 to 280 A/dm², from 1 to 200 A/dm², from 1 to 140 A/dm², from 1 to 80 A/dm² or from 1 to 40 A/d m², most particularly preferably in the range from 5 to 260 A/dm² or from 5 to 25 A/d m². The voltage is commonly—depending in particular on the size of the plant and the type of contacts—in the range from 0.1 to 50 V, in particular in the range from 1 to 20 V.

A direct current or an alternating current or a superposition of a direct current and an alternating current can be used as the current for electrolytic phosphating. Direct current or a superposition of direct current and alternating current is preferably used for electrolytic phosphating. The direct current can preferably have an amplitude in the range from 2 to 25 A/dm², particularly preferably in the range from 1 to 10 A/dm², in particular in the range from 5 to 30 A/dm². The alternating current can preferably have a frequency in the range from 0.1 to 100 Hz, particularly preferably in the range from 0.5 to 10 Hz. The alternating current can preferably have an amplitude in the range from 0.5 to 30 A/dm², particularly preferably in the range from 1 to 20 A/dm², most particularly preferably in the range from 1.5 to 15 A/dm², in particular in the range from 2 to 8 A/dm².

With a superposition of direct current and alternating current, the abovementioned electrical conditions can be combined. With a superposition of direct current and alternating current, the ratio of the direct current component to the alternating current component as with the aforementioned electrical conditions can be varied within broad limits. The ratio of direct current component to alternating current component is preferably kept in the range from 20:1 to 1:10, particularly preferably in the range from 12:1 to 1:4, most particularly preferably in the range from 8:1 to 1:2, above all in the range from 6:1 to 1:1, relative to the components measured in A/d m².

The substrate to be coated is connected as the cathode here. If however the substrate to be coated is connected as the anode, in some circumstances only a pickling effect occurs and in some cases no readily discernable coating is formed.

The contactable or contacted holder for the metallic substrate to be coated, such as e.g. for a wire, which is often used above the bath, can be made from any metallic electrically conductive material, preferably from an iron or copper material. It serves as a cathode and connects the substrate as the cathode. The flow of current between the cathode and the anode passes through the phosphating solution, which has good electrical conductivity.

The contactable or contacted anode is largely or entirely placed in the phosphating solution in the bath and is preferably made from a metallic, electrically conductive material which—in the event that it dissolves in the phosphating solution and accumulates, in some circumstances also as sludge—does not adversely affect the phosphating solution and the electrolytic phosphating process. Iron materials, which dissolve slowly in the bath and form an iron phosphate-rich sludge, are therefore also suitable in principle. The anode preferably consists of a material which is not dissolvable or only slightly dissolvable in the bath solution, based on titanium for example, which in particular because of its conductivity and possible slight dissolvability in the bath solution can also be coated with a noble metal from the 8^{th} subgroup of the periodic table.

If the metallic object to be coated is connected as the cathode and is coated electrolytically, there is little or no pickling attack in the acid phosphating solution—unlike the case with the currentless method. When iron anodes were used, iron nevertheless accumulated in the bath. In some circumstances this accumulation was up to around 10 g/l Fe²⁺. These quantities did not cause any problems. Larger amounts of Fe²⁺ can be precipitated out by the addition of at least one oxidising agent such as e.g. hydrogen peroxide, sodium chlorate or/and ambient oxygen. When platinum-plated titanium anodes, for example, were used, no iron accumulated in the bath. The use of a suitable oxidising agent is often advantageous because it allows the treatment time to be reduced, since the hydrogen produced in the electrochemical reaction is immediately oxidised to H⁺ ions and so the hydrogen gas, which often accumulates at the surface in bubbles, can no longer block the coating of the surface.

Under a scanning electron microscope, the phosphate coatings produced according to the invention often do not display the typical crystal shapes—unlike the chemically comparable phosphate coatings deposited without current—but instead on the one hand have particle-like formations which are often open in the middle like short sections of tubing and look as if they had been formed around a fine hydrogen bubble. These entities often have an average particle size in the range from 1 to 8 μm. The hydrogen bubbles could successfully be made finer by the addition of a particular accelerator such as e.g. nitroguanidine or alternatively avoided altogether by the addition of a reducing agent such as e.g. based on an inorganic or organic acid, the salts or/and esters thereof, so that the phosphate coatings do not have too much of a particulate appearance. On the other hand, there are some phosphate films, which can also be recognised by the particle-like entities, which in some cases appear to have burst open. It is particularly preferable to add a reducing agent, preferably in the range from 0.1 to 15 g/l, which in the pH range between 1 and 3 forms no poorly soluble compounds with calcium, magnesium or/and manganese, to the phosphating solution in order to influence and in particular to homogenise the morphology of the phosphate coating. In phosphate coatings with inadequate homogeneity, which are inadequately closed, clear differences are sometimes discernible in the formation of the phosphate coating in different areas of the sample. For that reason all phosphate coatings according to the invention differ significantly from phosphate coatings deposited without current.

Brushite, but not an apatite, was detected radiographically as the main constituent of the calcium-rich electrolytically deposited phosphate coatings. By the currentless method calcium-rich phosphating solutions produced no coating at all. The main constituent of the magnesium-rich or/and manganese-rich electrolytically produced phosphate coatings could not be detected radiographically even on thick coatings; instead, unlike the case with phosphate coatings deposited without current, it appears to be X-amorphous.

In order to deposit the phosphate coating according to the invention, the metallic substrate such as e.g. a wire or several wires isolated from one another and contacted separately, is connected as the cathode, introduced into the bath with the phosphating solution and coated electrolytically using a current. Once the current has been switched off, the coated substrate can be removed from the bath. Alternatively, in continuous processes the coated substrate can be transported to bath sections in which there is no significant current flow or no current flow at all, and in which no significant electrolytic coating or no electrolytic coating at all is thus applied in the bath, and removed there.

It was found, however, that on wires in coating weights of more than 18 g/m² the phosphate coatings according to the invention often have less adhesive strength before being coated with at least one lubricant or with at least one lubricant composition. Coatings of less than 2.5 g/m² on wires often have a limited release effect on the coating system between the wire and die because the coating is too thin, so that in cold forming the wire and die can easily be cold welded, causing striation, wire breakage, mechanical separation of the welded remainder of the wire from the die or/and damage to the die. For wires the particularly preferred coating weight range is mostly between 3 and 10 g/m².

The coating weights obtained for the phosphate coatings are preferably in the range from 1 to 20 g/m², in particular in the range from 2 to 15 g/m², for a wire and in the range from 2 to 50 g/m² for a metallic substrate having a larger surface area in comparison to a wire. The coating weight is obtained as a function of the current density and treatment time.

In cold extrusion of bosses, for example, the preferred coating weight of the phosphate coating before coating with at least one lubricant or with at least one lubricant composition is in the range from 2 to 40 g/m², in particular in the range from 5 to 30 g/m², above all in the range from 8 to 20 g/m².

With metallic substrates having a comparatively large surface area the coating weight of the phosphate coating can preferably be in the range from 0.5 to 200 g/m², particularly preferably in the range from 5 to 50 g/m², most particularly preferably in the range from 2 to 20 g/m² or from 8 to 40 g/m². In a half-hour experiment with continuous coating, largely in accordance with example 27, a coating of more than 200 g/m² was obtained which above around 200 g/m² became spongy or/and crumbly, however.

In total, the coating weight of the phosphate coating before the application of lubricant(s) can preferably be in the range from 1 to 60 g/m², particularly preferably in the range from 2 to 40 g/m². The phosphate coating commonly has a thickness in the range from 0.5 to 40 μm, often in the range from 1 to 30 μm.

At least one lubricant or at least one lubricant composition having at least one substance selected from soaps, oils, organic polymers and waxes is preferably applied to this phosphate coating in at least one layer.

The following are mostly used as lubricants or lubricant compositions, each of which displays at least one of the substances cited below, optionally also in combination with one another:
1. Metal soaps based on alkali metal, which are water-soluble and are able to be reacted chemically at least partly with the phosphates in the phosphate coating and which are preferably applied in liquid form, mainly as sodium soap,
2. Metal soaps based on alkaline-earth metal, in particular as aluminium, calcium or/and zinc soap, which are water-insoluble and which are unable or scarcely able to be reacted chemically with the phosphates in the phosphate coating and for that reason are preferably used as a powder or in the form of a paste,
3. Oils,
4. Flexible or/and reactive organic polymers, which like certain organic polymers based on (meth)acrylate or/and polyethylene, for example, display lubricating properties, and
5. Waxes such as e.g. crystalline waxes, which can optionally be mixed with at least one each of a metal soap, layered silicate, additive and agent to increase the viscosity of the solution or suspension, such as e.g. starch.

These lubricants or lubricant compositions can be used in the process according to the invention following phosphating.

Liquid lubricants or lubricant compositions can be applied to the workpieces by dipping in a bath, for example. Powdered or paste-like lubricants or lubricant compositions are preferably placed in a die box, through which a wire, for example, can be drawn and coated.

At least one lubricant coat can subsequently be applied to the at least one phosphate coating, preferably in a thickness in the range from 1 to 40 μm, particularly preferably in the range from 2 to 30 μm, usually with a coating weight in the range from 1 to 40 g/m², often with a coating weight in the range from 3 to 30 g/m², sometimes with a coating weight in the range from 5 to 18 g/m². If a reactive stearate-containing solution or suspension is used—as with many wires—this produces a coating system which together with the phosphate coating is substantially in three layers and mostly has a more or less non-uniform structure. If on the other hand a non-reactive stearate-containing mixture is used, particularly in the form of powder or a paste, this produces a coating system which together with the phosphate coating is substantially in two layers and often has a largely uniform structure. In total, this stack of layers preferably has a thickness in the range from 2 to 100 μm, particularly preferably in the range from 4 to 75 μm, most particularly preferably in the range from 6 to 50 μm, in particular in the range from 8 to 25 μm. The phosphate coating which is optionally at least partly chemically transformed and the at least one lubricant coat which is optionally partly chemically transformed commonly together display a coating weight in the range from 2 to 100 g/m². The metallic workpieces coated in this way can then be cold formed.

If the metallic substrate is in a phosphating solution without current before electrolytic phosphating, only a pickling or almost only a pickling usually occurs but no major coating deposition. If the bath with the coated substrate is kept currentless after electrolytic phosphating, a phosphate coating can in many cases slowly chemically dissolve or partially dissolve again.

Pretreatment of the metallic substrates, in particular of wires, bosses or rods, before electrolytic deposition of phosphate advantageously comprises mechanical scouring, alkaline cleaning or/and pickling, wherein at least one rinsing stage with water is usually chosen between or after each aqueous process stage.

A lubricant coat is generally required on top of the phosphate coating for the cold forming of metallic substrates. These layers are usually applied separately one after another, but they can also blend fluidly into one another after a chemical reaction e.g. with reactive liquid soaps. The stronger chemical reaction of reactive metal soaps requires a certain water content and elevated temperatures, preferably in the range from 50 to 98° C. For that reason little or no chemical reaction usually occurs with powdered or paste-like soaps. The powdered or paste-like soaps are therefore mostly based on calcium stearate.

Phosphate coatings must be combined with a suitable lubricant coat for cold forming. These are mostly sodium stearates in liquid or powdered form or/and calcium stearates in powdered form, which in particular can be stored in a die box and applied there during the drawing process.

The lubricant coat is usually placed in the die box in the form of a powder or paste, e.g. as a drawing soap (powdered soap) or stored as a reactive soap solution or soap suspension in a temperature-controlled bath. When the phosphated metallic workpiece is passed through the heated bath the reactive liquid soap is applied, giving rise to a chemical reaction with the phosphate coating.

The applied lubricant coat(s) preferably has/have a coating weight in the range from 1 to 50 g/m², particularly preferably in the range from 3 to 35 g/m², most particularly preferably in the range from 5 to 20 g/m². The lubricant coat(s) then often has/have a thickness in the range from 1 to 50 μm, commonly a thickness in the range from 3 to 35 μm, sometimes a thickness in the range from 5 to 20 μm.

A suitable solution or suspension for the aftertreatment of the phosphated workpiece surfaces by dipping in particular preferably contains 2 to 100 g/l of ammonium, sodium, potassium, aluminium or/and zinc stearate or mixtures of at least one of these stearates with at least one further substance and optionally an addition of at least one complexing agent, which is capable of complexing aluminium/calcium/magnesium/manganese/zinc from the aluminium-/calcium-/magnesium-/manganese-/zinc-rich phosphate coatings. These can be additions of sodium citrate or/and sodium gluconate, for example. Ammonium stearate, however, cannot usually be reacted chemically with the phosphates. The pH of such solutions is preferably in the range between 9 and 12. The reactive liquid soap is applied in particular at a temperature in the range from 60 to 90° C.

In many cases it is advantageous not to react the at least one stearate compound stoichiometrically but instead to adjust it so that it is slightly hyperalkaline, in order to improve the hydrolytic attack on the calcium/magnesium/manganese phosphate. They then preferably have a pH in the range from 9 to 12.5.

Cold forming can be a) slide drawing such as e.g. wire drawing or tube drawing, b) cold massive forming such as e.g. cold extrusion, cold upsetting or ironing, or c) deep drawing.

The metallic workpieces coated in this way are preferably cold-formed and optionally then annealed, ground, lapped, polished, cleaned, rinsed, coated with at least one metal e.g. by bronzing, chroming, coppering, nickeling, zincing, without current, by electroplating or/and with a melt, coated with at least one pretreatment or/and passivating composition, coated with at least one organic composition such as e.g. a primer, paint, adhesive or/and plastic such as e.g. based on PVC, or/and processed to make a composite component.

Contrary to initial expectations, electrolytic phosphating with a phosphating solution containing calcium, magnesium or/and manganese not only released hydrogen but also deposited a phosphate coating.

These phosphate coatings even proved often to be of very high quality. They frequently have a very uniform, attractive appearance, often similar to a matt paint film, particularly when there is an elevated manganese content. This is because they are often finer-grained, smoother and more attractive than a conventional phosphate coating produced without current.

Surprisingly it was established that the conditions and results are significantly different for currentless and electrolytic coating. For example, the electrolytically deposited phosphate coatings are significantly different as compared to the phosphate coatings produced without current, being usually of lower crystallinity, which means that they are often without a marked formation of crystal shapes in the coating. Electrolytic phosphating was also able to take place at room temperature, whereas the comparable currentless phosphating generally requires temperatures of significantly more than 40° C. Furthermore, in some embodiments the pH must be reduced slightly for electrolytic coating in comparison to currentless coating in order to bring about the deposition of a coating.

Surprisingly it has now been found that the phase stability of the electrolytically produced coatings and their colour or the formation of a coating differs significantly from coatings produced without current.

Surprisingly the electrolytic formation of the phosphate coating takes place at a significantly higher speed than with currentless methods.

Nozzles in particular, such as e.g. injection nozzles, engine components and some parts for weapons, are subject to sliding friction use. Phosphate coatings having an elevated manganese content are particularly suitable for this purpose.

Furthermore it was surprisingly established that—particularly in the case of long workpieces such as wires, rods and strips—an increase in the current density to values of several hundred A/dm² or/and in the current intensity is advantageous in order to avoid having to increase excessively the size of the plant required—particularly at high throughput rates such as from 30 to 120 m/min, for example. Astonishingly, even with very high throughput rates, very short coating times and with high current intensities, good coatings were obtained (examples 26 and 27).

The metallic workpieces, particularly also strips or sheets, which are coated with at least one phosphate coating, can subsequently be used in particular for cold forming or/and for sliding friction use. At least one substantially organic coating can optionally be applied before or/and after at least one cold forming.

### EXAMPLES AND COMPARATIVE EXAMPLES

The examples described below are intended to illustrate the subject of the invention in more detail without restricting it.

Test Series 1 on Short Sections of Cold-Upsetting Wire:

Phosphating solutions having bath compositions according to Table 1 were prepared by diluting concentrated phosphoric acid with water and then adding the alkaline-earth metal or manganese ions in the form of water-soluble nitrates. The entire nitrate content came from these salts. The accelerators were then added (chlorate, nitroguanidine, etc.). Finally the pH was adjusted to values of 1.9 or 2.0 by the addition of sodium hydroxide solution. A standard electrode was used for the pH measurement, even though this is comparatively imprecise in the low pH range. The experiments were performed at a temperature of about 20° C.

A single cold-upsetting steel wire made from 19MnB4 steel with a 5.7 mm diameter, which had first been cleaned by alkaline cleaning and rinsing followed by pickling in dilute acid and rinsing, was used for the coating experiments.

The cleaned cold-upsetting steel wire was introduced vertically into the centre of a beaker with a capacity of 1 litre and clamped in a holder above the water level of the phosphating solution in the beaker, held in place and brought into electrical contact. Symmetrically to the vertically supported wire, a substantially cylindrical platinised titanium anode, connected to an electricity supply, was held at a distance of about 1 cm from the wire. The anode reached up to just below the water level. The wire was preferably approximately exactly as long as the length of anode immersed in the solution. If the length of wire immersed in the solution was significantly shorter than that of the titanium anode, the phosphate deposition was greater in the lowest part of the wire than in the other sections of the wire, as was clearly visible from the colour change. If the length of wire immersed in the solution was significantly longer than that of the titanium anode, less or no phosphate was deposited in the lowest part of the wire, as was clearly visible from the colour change. The colour of the coating depends on the one hand on the film thickness and on the other on the chemical composition of the coating.

The wire was connected as the cathode, introduced vertically into the beaker with the phosphating solution and current was then applied immediately. After the treatment time, which represents the time for which the current is applied, the current was disconnected and the wire immediately removed, rinsed and dried with compressed air. If however the titanium anode was connected as cathode and the wire as anode, there was only a pickling effect, with no readily discernable coating.

If only alternating current was applied for the electrolytic coating process, then little or no deposition occurred. The proportion that was deposited was obviously dissolved again immediately. If only direct current was applied for the electrolytic coating process, then adequately good to very good coatings were produced. If direct current and alternating current were applied simultaneously for the electrolytic coating process, in particular by superposition of the two current types, then good to very good coatings were produced, which were however somewhat more finely grained than those formed by direct current alone. A direct current component in which the current density of the direct current component is roughly one to two and a half times greater than the current density (amplitude) of the alternating current component, e.g. 6, 8, 10, 12, 14 or 16 A direct current component combined with e.g. 5, 6, 7 or 8 A alternating current component, proved particularly successful. Clipping the phase components of the alternating current component does not have a very strong effect. If the frequency was varied in connection with the experiments that were performed, it had no significant influence on the coating result.

If hydrofluoric acid or/and a complex fluoride was added to the phosphating solution, precipitations occurred in calcium- and magnesium-rich solutions.

Surprisingly it was found that the phase stability of the electrolytically produced coatings and their colour or the morphological formation of a coating differs significantly from coatings produced without current: none of the samples phosphated according to the invention displayed any pickling effect, unlike the case with the samples phosphated without current. Surprisingly, brushite, CaH(PO₄).2H₂O, was determined as the main constituent of the calcium-rich phosphate coats produced electrolytically, but no calcium orthophosphate such as e.g. an apatite, whereas in the currentless method no coating was formed at all and only a pickling effect occurred. Brushite is more advantageous than an apatite such as e.g. hydroxyl apatite, since brushite is less resistant to alkali and can be chemically reacted with alkali soaps more easily than an apatite. The main constituent of the magnesium-rich electrolytically produced phosphate coats could not be detected radiographically even on thick coatings; instead, unlike the case with phosphate coatings deposited without current, it appears to be X-amorphous. The main constituent of the manganese-rich electrolytically produced phosphate coatings could not be identified radiographically either and likewise appears to be X-amorphous. Table 1 shows the compositions of the treatment baths, the deposition conditions and the coating results. A high level of process reliability was achieved with the calcium- and manganese-rich phosphate coatings.

TABLE 1
Composition of the treatment baths, deposition conditions and coating results

| | E 1 | E 2 | E 3 | E 4 | E 5 | E 6 | E 7 | E 8 | E 9 | E 10 | E 11 | E 12 |
|---|---|---|---|---|---|---|---|---|---|---|---|---|
| Additions in g/l | | | | | | | | | | | | |
| PO₄ | 39.0 | 39.0 | 43.3 | 19.5 | 49.9 | 39.0 | 39.0 | 39.0 | 39.0 | 39.0 | 39.0 | 9.7 |
| P₂O₅ | 29.3 | 29.3 | 31.5 | 14.7 | 37.5 | 29.3 | 29.3 | 29.3 | 29.3 | 29.3 | 29.3 | 7.3 |
| Ca | 22.0 | 22.0 | 15.8 | 11.0 | 32.2 | 22.0 | 22.0 | 22.0 | 22.0 | 22.0 | 11.1 | 5.5 |
| Mg | — | — | — | — | — | — | — | — | — | 5.0 | 11.1 | — |
| Mn | — | — | — | — | — | — | — | — | — | — | — | — |
| NO₃⁻ | 68.2 | 68.2 | 47.3 | 34.1 | 99.8 | 68.2 | 68.2 | 68.2 | 68.2 | 93.7 | 85.1 | 17.0 |
| ClO₃⁻ | 26.7 | — | — | 13.2 | — | — | — | — | — | — | — | 6.3 |
| Citrate | — | — | 10.0 | — | — | — | — | — | — | — | — | — |
| Nitroguanidine | — | — | — | — | — | 1.0 | — | — | — | — | — | 1.0 |
| Hydroxylamine sulfate | — | — | — | — | — | — | 1.0 | — | — | — | — | — |
| SNBS | — | — | — | — | — | — | — | 1.0 | — | — | — | — |
| Na perborate NaBO₃•4H₂O | — | — | — | — | — | — | — | — | 8.7 | — | — | — |
| pH | 2.0 | 1.9 | 2.0 | 2.0 | 2.0 | 2.0 | 2.0 | 2.0 | 2.0 | 2.0 | 2.0 | 2.6 |
| Solution density g/cm³ | 1.10 | 1.08 | 1.05 | 1.05 | 1.13 | 1.08 | 1.08 | 1.08 | 1.08 | 1.10 | 1.114 | 1.03 |
| FS | 11.20 | 16.80 | 11.90 | 5.90 | 11.10 | 11.70 | 12.10 | 11.90 | 11.10 | 10.40 | 7.60 | 1.90 |
| GSF | 42.20 | 37.40 | 44.90 | 21.00 | 57.00 | 45.20 | 46.00 | 45.60 | 42.00 | 44.10 | 42.20 | 11.40 |
| GS | 81.1 | 76.0 | 76.6 | 42.0 | 115.0 | 78.0 | 82.0 | 80.4 | 81.3 | 84.2 | 84.7 | 21.8 |
| S value | 0.25 | 0.45 | 0.28 | 0.28 | 0.19 | 0.26 | 0.26 | 0.26 | 0.24 | 0.24 | 0.18 | 0.17 |
| Deposition conditions | | | | | | | | | | | | |
| Average voltage V | 4 | 4.5 | 4 | 6.5 | 3.5 | 5.5 | 5.5 | 4.5 | 4 | 4.5 | 4.5 | 7 |
| Altern. current comp. A/dm² | 5 | 3 | 5 | — | — | 6.5 | — | — | — | 10 | — | — |
| Frequency Hz | 1 | 1.5 | 1 | — | — | 1 | — | — | — | 1 | — | — |
| Direct current comp. A/dm² | 10.0 | 10.9 | 10.0 | 13.4 | 13.0 | 13.0 | 16.0 | 7.3 | 13.5 | 19.1 | 14.6 | 11.4 |
| Treatment time s | 10 | 10 | 5 | 10 | 5 | 10 | 5 | 10 | 5 | 5 | 5 | 10 |
| Colour of coating | white | pale | grey | white | white - | white | pale | grey | grey | grey | grey | grey |
| | | grey | | | pale | | grey | | | | | |
| | | | | | grey | | | | | | | |
| Visual film quality | very | good | moderate | good | good | good | moderate | good | good | good | good | poor |
| | good | | | | | | | | | | | |
| Adhesive strength of film | moderate | good | good | good | good | very | good | moderate | good | good | good | good |
| | | | | | | good | | | | | | |
| Coating weight g/m² | 10.3 | 5.9 | 4.3 | 7.6 | 5.0 | 10.0 | 6.1 | 4.2 | 4.1 | 6.6 | 4.6 | 1.0 |
| Deposition speed | 4.4 | 3.3 | 3.1 | 3.4 | 4.6 | 4.0 | 3.7 | 3.4 | 4.0 | 4.1 | 3.8 | 0.5 |
| for 1 A/dm² over 1 min | | | | | | | | | | | | |

| | E 13 | E 14 | E 15 | E 16 | E 17 | E 18 | E 19 | E 20 | E 21 | E 22 | E 23 | E 24 |
|---|---|---|---|---|---|---|---|---|---|---|---|---|
| Additions in g/l | | | | | | | | | | | | |
| PO₄ | 39.0 | 19.5 | 39.0 | 39.0 | 19.5 | 39.0 | 39.0 | 39.0 | 39.0 | 39.0 | 39.0 | 39.0 |
| P₂O₅ | 29.3 | 14.6 | 29.3 | 29.3 | 14.7 | 29.3 | 29.2 | 29.3 | 29.3 | 29.2 | 29.3 | 29.3 |
| Ca | — | — | 11.0 | — | — | — | — | — | — | — | 22.0 | 22.0 |
| Mg | 31.5 | 15.7 | — | 11.6 | — | — | — | — | — | 31.5 | — | — |
| Mn | — | — | 11.2 | 11.2 | 15.1 | 30.2 | 50.0 | 50.0 | 30.2 | — | — | — |
| NO₃⁻ | 160.6 | 80.3 | 59.3 | 84.7 | 34.1 | 68.2 | 112.9 | 112.9 | 68.2 | 160.6 | 68.2 | 68.2 |
| ClO₃⁻ | — | — | 26.4 | — | — | — | — | — | — | 26.7 | 26.7 | 10.0 |
| Citrate | — | — | — | — | — | — | — | — | — | — | — | — |
| Nitroguanidine | — | — | — | — | — | — | — | — | 1.0 | — | 1.0 | 1.0 |
| Hydroxylamine sulfate | — | — | — | — | — | — | — | — | — | — | — | — |
| SNBS | — | — | — | — | — | — | — | — | — | — | — | — |
| Na perborate NaBO₃•4H₂O | — | — | — | — | — | — | — | — | — | — | — | — |
| H₂ZrF₆ | — | — | — | — | — | — | — | 0.5 | — | — | — | — |
| Heterocyclic acid | — | — | — | — | — | — | — | — | 5.0 | — | — | — |
| Ph | 1.5 | 1.7 | 1.9 | 2.2 | 2.2 | 2.0 | 1.5 | 1.5 | 2.0 | 1.5 | 2.0 | 2.0 |
| Solution density g/cm³ | 1.17 | 1.05 | 1.12 | 1.11 | 1.05 | 1.12 | 1.16 | 1.16 | 1.12 | 1.18 | 1.10 | 1.10 |
| FS | 9.2 | 7.2 | 11.8 | 7.5 | 5.5 | 10.0 | 11.2 | 11.2 | 8.6 | 9.3 | 11.8 | 11.8 |
| GSF | 41.6 | 22.5 | 44.0 | 48.0 | 22.2 | 45.0 | 42.4 | 42.4 | 43.6 | 40.5 | 43.5 | 43.5 |
| GS | 80 | 50 | 89 | 80 | 49 | 80 | 170 | 170 | 91 | 81 | 92 | 92 |
| S value | 0.22 | 0.32 | 0.27 | 0.16 | 0.25 | 0.22 | 0.26 | 0.26 | 0.20 | 0.23 | 0.27 | 0.27 |
| Deposition conditions | | | | | | | | | | | | |
| Average voltage V | 6.5 | 6.0 | 5.0 | 5.0 | 5.0 | 6.0 | 5.0 | 5.0 | 5.5 | 6.5 | 5.0 | 4.0 |
| Altern. current comp. A/dm² | — | — | — | — | — | — | — | 7.3 | — | — | — | — |
| Frequency Hz | — | — | — | — | — | — | — | 1 | — | — | — | — |
| Direct current comp. A/dm² | 21.0 | 11.5 | 13.7 | 5.7 | 12.2 | 17.0 | 14.6 | 14.6 | 13.5 | 12.0 | 12.0 | 6.3 |
| Treatment time s | 20 | 30 | 5 | 10 | 10 | 15 | 10 | 10 | 10 | 30 | 5 | 10 |
| Colour of coating | white | pale | white - | grey | white | white | white - | white - | white | white | white - | grey |
| | | grey | pale | | | | pale | pale | | | pale | |
| | | | grey | | | | grey | grey | | | grey | |
| Visual film quality | moderate | moderate | good | moderate | very | very | Good | good | very | moderate | good | good |
| | | | | | good | good | | | good | | | |
| Adhesive strength of film | good | good | good | good | good | good | very | very | very | moderate | good | very |
| | | | | | | | good | good | good | | | good |
| Coating weight g/m² | 9.9 | 5.4 | 4.8 | 4.4 | 7.4 | 7.7 | 7.4 | 7.5 | 8.8 | 6.0 | 5.8 | 4.8 |
| Deposition speed for 1 A/dm² | 1.4 | 0.9 | 4.2 | 4.6 | 3.6 | 2.9 | 3.0 | 3.1 | 3.9 | 1.1 | 4.5 | 4.6 |
| over 1 min, g/m² | | | | | | | | | | | | |

| | E 25 | E 26 | E 27 | E 28 | CE 1 | CE 2 | CE 3 | CE 4 | CE 5 | CE 6 |
|---|---|---|---|---|---|---|---|---|---|---|
| Additions in g/l | | | | | | | | | | |
| PO₄ | 39.0 | 39.0 | 39.0 | 39.0 | 39.0 | 39.0 | 39.0 | 39.0 | 179 | 179 |
| P₂O₅ | 29.3 | 29.3 | 29.3 | 29.3 | 29.3 | 29.3 | 29.3 | 29.3 | 135 | 135 |
| Ca | 22.0 | 22.0 | 22.0 | 22.0 | 22.0 | — | — | 11.1 | 74.8 | 74.8 |
| Mg | — | — | — | — | — | 23.3 | — | 11.1 | —Zn: 45 | —Zn: 45 |
| Mn | — | — | — | — | — | — | 30.2 | — | — | — |
| NO₃⁻ | 68.2 | 68.2 | 68.2 | 68.2 | 68.2 | 159.6 | 68.3 | 85.1 | 236 | 236 |
| ClO₃⁻ | — | — | — | — | — | — | — | — | — | — |
| Citrate | — | — | — | — | — | — | — | — | — | — |
| Nitroguanidine | 1.0 | 1.0 | 1.0 | 1.0 | — | — | — | — | — | — |
| Hydroxylamine sulfate | — | — | — | — | — | — | — | — | — | — |
| SNBS | — | — | — | — | — | — | — | — | — | — |
| Na perborate NaBO₃•4H₂O | — | — | — | — | — | — | — | — | — | — |
| H₂ZrF₆ | — | — | — | — | — | — | — | — | — | — |
| Heterocyclic acid | 5.0 | — | — | — | — | — | — | — | — | — |
| pH | 2.0 | 1.8 | 1.8 | 1.8 | 1.9 | 1.5 | 2.0 | 2.0 | 2.0 | 2.0 |
| Solution density g/cm³ | 1.08 | 1.10 | 1.10 | 1.10 | 1.08 | 1.17 | 1.12 | 1.11 | 1.37 | 1.37 |
| FS | 10.5 | 12.0 | 12.0 | 12.0 | 16.8 | 9.2 | 10.0 | 7.6 | 9.4 | 9.4 |
| GSF | 48.2 | 44.4 | 44.4 | 44.4 | 37.4 | 41.6 | 45.0 | 42.2 | 34.4 | 34.4 |
| GS | 81 | 95 | 95 | 95 | 76 | 80 | 80 | 85 | 74 | 74 |
| S value | 0.22 | 0.29 | 0.29 | 0.29 | 0.45 | 0.22 | 0.22 | 0.18 | 0.27 | 0.27 |
| Deposition conditions | | | | | | | | | | |
| Average voltage V | 5.0 | 10.0 | 15.0 | 5.0 | — | — | — | — | 4 | 5-15 |
| Altern. current comp. A/dm² | — | — | — | — | — | — | — | — | — | — |
| Frequency Hz | — | — | — | — | — | — | — | — | — | — |
| Direct current comp. A/dm² | 16.0 | 130.0 | 260.0 | 8.5 | — | — | — | — | 4.1 | 3.7 |
| Treatment time s | 5 | 0.8 | 0.25 | 900 | 120 | 120 | 120 | 120 | 120 | 120 |
| Colour of coating | white | grey | grey | yellowish- | — | — | — | — | grey | dark |
| | | | | grey | | | | | | grey |
| Visual film quality | very | good | good | almost | no coating deposited | | | | spotty, | poor *) |
| | good | | | good | because currentless | | | | average | |
| Adhesive strength of film | good | good | very | almost | | | | | good | almost |
| | | | good | good | | | | | | good |
| Coating weight g/m² | 6.5 | 6.5 | 5.0 | 138.7 | 0 | 0 | 0 | 0 | 6.8 | 4.6 |
| Deposition speed for 1 A/dm² | 4.9 | 3.8 | 5.8 | 1.1 | — | — | — | — | 1.6 | 0.6 |
| over 1 min, g/m² | | | | | | | | | | |

*) Deposition of Ca phosphate and black metallic zinc even at slightly elevated temperature: dusty-looking coating

In examples E 26 and E 27, higher-speed coatings were tested. Astonishingly, these experiments produced good coatings, so plants for wire phosphating, for example, can be kept correspondingly short and do not have to be e.g. 8 to 10 m in length, since a coating operation does not have to last for e.g. 5 s but also delivers good results over, a fraction of 1 s. The aim of example E 28 was to establish what coating speeds are possible in principle and what the resulting properties are. Here it was found that under the chosen conditions an almost good coating is possible up to a period of around 1500 s; although coating can continue beyond this time, the thicker the coatings, the greater the likelihood of part of the coating peeling away easily from the metallic substrate and the proportionally greater the effect. The experiment was terminated at 3200 s. Above around 800 s the coating began to become slightly spongy.

It is a different matter with an electrolytic phosphating, e.g. in the Ca—Zn system as in comparative examples 5 (20° C.) and 6 (40° C.). The metallic zinc, which can be deposited in significant amounts even at slightly elevated temperatures above at least 40° C., gives the phosphate coating a dark to black colour. A small amount of zinc is possibly also deposited below 40° C. Metallic zinc has a disruptive effect in the coating that is formed since the melting point of zinc is significantly lower than that of phosphate and for example cold welding of the zinc to the drawing die or/and the workpiece can easily occur in the drawing gap in cold forming. These cold welds then readily lead e.g. to scoring on the workpiece and drawing die, as a result of which the workpiece has to be rejected and the drawing die polished again before it can be reused.

As hoped, despite the very low pH values—in so far as almost only or only electrolytic phosphating was effective—there was no significant pickling effect due to the polarisation and hence no visible concentration in the phosphating solution of the cations such as e.g. iron dissolved out of the substrate surface. For that reason there was no or virtually no sludge formation, which dramatically reduces the costs for disposal of the sludge. Furthermore, the electrolytically deposited phosphate coatings were surprisingly particularly finely grained or amorphous in comparison to phosphate coatings produced without current. The phosphate coatings produced according to the invention are astonishingly often so finely grained, uniform and even that they look as if they have been coated with a matt paint, whereas the phosphate coatings produced without current always look somewhat rougher and often less uniform due to differences in grey tints.

The film quality assessed here relates to a visual assessment of the film in terms of overall visual impression, homogeneity and opacity (closed or incompletely closed). The film quality was assessed as very good if the phosphate coating looked “attractive”, uniform and closed to the naked eye. It was regarded as moderately good if it displayed slight colour differences, which indicate varying coating weights on the substrate. The abrasion resistance (=adhesive strength) was determined separately.

In the various types of compositions it was surprisingly found that calcium, magnesium and manganese are in principle very or even extremely suitable as cations for electrolytic phosphating for cold forming. Calcium and manganese generally perform better than magnesium as cations. Although manganese produced the best film qualities with no further optimisation attempts, it must also be borne in mind that as a heavy metal manganese has greater significance in terms of environmental issues than an alkaline-earth metal cation.

Ca(NO₃)₂.4H₂O was added to the calcium-rich phosphating solutions. Calcium-containing phosphating solutions showed that it is possible to work successfully within broad chemical and electrical ranges. The concentration of calcium and phosphate was varied within broad limits. In Example E 12 according to the invention it was found that the contents of calcium and phosphate were too low to be able to deposit an adequately thick, completely closed phosphate coating, even with high current densities.

Furthermore, the influence of the accelerators was unexpectedly high. A chlorate content had a slightly negative effect on the abrasion resistance of the phosphate coating but on the other hand it led to a particularly rapid deposition and a particularly finely grained phosphate coating. Thicker phosphate coatings can normally be obtained with chlorate than with other additives under the same conditions. A borate content likewise had a slightly adverse effect on the abrasion resistance of the phosphate coating but produced a more medium-grain coating. Accelerators based on guanidine, hydroxylamine or nitrobenzene sulfonate produced an excellent film quality, with nitroguanidine proving the most successful. An addition of nitroguanidine increased the adhesive strength markedly. A combination of chlorate and nitroguanidine often brought about very good results. An addition of hydroxylamine sulfate or nitrobenzene sulfonate likewise improved the adhesive strength markedly, but led to a somewhat less homogeneous appearance of the phosphate coatings. The addition of a reducing agent such as e.g. an organic heterocyclic acid to calcium-rich phosphating solutions (E 25) evidently further reduced the development of hydrogen bubbles and significantly homogenised the morphology of the phosphate coating.

A short-term experiment adding tap water instead of demineralised water made no difference. An addition of manganese to calcium did not lead to optimum results in the first experiment (E 15) but indicated a high potential for optimisation with modifications to the chemical and electrical conditions. Mg(NO₃)₂.6H₂O was added to the magnesium-rich phosphating solutions. The generally very low S value of these solutions was raised by the addition of nitric acid, which reduced the pH to values of about 1.5. When added as the only or main cation, magnesium displayed comparatively low and sometimes even too low deposition rates and sometimes also incompletely closed phosphate coatings, although their adhesive strength was always sufficiently high. The influence of the added accelerator was similar to that in the calcium-rich phosphating solutions, but the accelerating effect was often somewhat smaller. The addition of an oxidising agent had almost no effect: only the deposition rate increased slightly, but it did not lead to finer coats. The magnesium-rich phosphate coatings were white to grey and mostly somewhat darker than comparable calcium-rich phosphate coatings.

Moreover, it was established in further experiments that an addition of hydrofluoric acid or/and at least one complex fluoride such as e.g. H₂ZrF₆ or/and H₂/TiF₆ to calcium- or/and magnesium-rich phosphating solutions led to precipitation of the cations, in other words obviously to precipitations of calcium fluoride or/and magnesium fluoride.

Mn(NO₃)₂.4H₂O was added to the manganese-rich phosphating solutions. The best film qualities and fine-grain phosphate coatings were obtained straight off in these experiments. Slight precipitations of a brown precipitate, presumably manganese dioxide, were found in the bath, however, although they had no adverse effect on the phosphate coating. The precipitations of manganese compounds could be completely suppressed, however, by the addition of a reducing agent such as e.g. based on an organic acid such as e.g. based on a heterocyclic acid or based on an inorganic acid such as e.g. sulfurous acid and other reducing agents known in principle, which form no poorly soluble compounds with calcium, magnesium or/and manganese in the pH range between about 1 and 3. The manganese-rich phosphate solution also remained pale pink and clear for a relatively long time as a consequence. Conversely, a manganese compound can be precipitated with the addition of an oxidising agent such as e.g. hydrogen peroxide, sodium chlorate or ambient oxygen. The influence of the added accelerator occurred in a similar way to that in the calcium-rich phosphating solutions, but the accelerating effect was often somewhat smaller. Astonishingly, the manganese phosphate coatings are not brownish, dark grey or black as is the case with currentless phosphating, but instead are white to white-grey, also grey if there is an additional magnesium content. Radiographic analysis of the manganese phosphate coating could not identify a crystal phase, however, since it is clearly X-amorphous.

Test Series 2 to React Phosphate with Reactive Soaps:

Cold-upsetting wires were treated for the same period of time under the same conditions with a calcium-rich phosphating solution according to Example 6 in Table 1 and then coated with a sodium-stearate-containing soap solution at 75° C. Table 2 shows the different soaping conditions and their results. The three different coating weights on the soaped wire can be determined because of the differing solubility of the various stearates and phosphates in different solvents. As high a calcium stearate coating weight as possible is desirable, without the remaining phosphate coating becoming too thin. It was found that with a soaping time of less than 5 seconds the reaction of calcium phosphate to form calcium stearate decreased. Surprisingly, it is therefore possible to use pleasingly short soaping times of around 5 seconds, whereas soaping times of around 10 minutes are otherwise often customary in dipping plants. It is therefore possible to operate successfully with soaping times in the range from 4 to 20 s in particular.

TABLE 2
Treatment conditions and reaction results for calcium
hydrogen phosphate with sodium stearate

| | | | | | Residual |
|---|---|---|---|---|---|
| | | | Na stearate | Ca stearate | phosphate |
| | Phosphating | Soaping time, | coating weight, | coating weight, | coating weight, |
| | time, s | s | g/m² | g/m² | g/m² |
| 1 | 10 | 2 | 1.6 | 1.4 | 7.8 |
| 2 | 10 | 5 | 1.7 | 2.7 | 6.3 |
| 3 | 10 | 10 | 1.9 | 2.6 | 6.8 |
| 4 | 10 | 15 | 1.7 | 2.6 | 6.8 |

Test Series 3 for Drawing Wire Rods:

In a third series of experiments, phosphate coatings were deposited on two-metre-long wire rod sections with the phosphating solution according to Example 1 in Table 1, corresponding to the electrical conditions cited therein. A wire rod with a 0.65 wt. % carbon content was used as the wire material, which had been treated by pickling with hydrochloric acid at 20° C. for 15 minutes.

The wire sections were briefly introduced into the phosphating solution and coated electrolytically for 10, 8 or 5.5 seconds at 20° C. A platinum-coated titanium material was once again used as the anode. The coating weight was 6.5 g/m² Ca phosphate in experiment 1, 5.1 g/m² Ca phosphate in experiment 2 and 4.3 g/m² Ca phosphate in experiment 3. The phosphate coating was white, very homogeneous, with adequate adhesive strength and with a fine-crystalline film structure. The aftertreatment of these phosphate coatings was carried out in experiment 1 with a reactive liquid sodium soap by dipping, in experiment 2 by drawing with Gardolube® DP 9010, a sodium soap in powder form from Chemetall GmbH, and in experiment 3 by application of a non-reactive calcium soap in powder form. The stearate coating had a coating weight of about 5 g/m² in each case.

In comparison to this, in experiment 4 a commercial zinc phosphating solution, Gardobond® Z 3570 from Chemetall GmbH, was applied at 90° C. without current for a dipping time of 20 seconds. It produced a coating weight of 5.5 g/m². This phosphate coating was aftertreated with a commercial sodium soap, Gardolube® L 6176 from Chemetall GmbH, by dipping, producing a zinc stearate coating of 2.2 g/m².

All wire sections coated with this coating system were drawn in a single drawing die on a large laboratory wire drawing machine with output speeds of up to 1 metre per second. After the application of a lubricant coat the wire sections phosphated according to the invention could be formed by slide drawing as well and as quickly as those with zinc phosphate coatings.

Furthermore, in comparative experiment 5 the same zinc phosphating solution was first applied under the same conditions as in comparative experiment 4, followed by a sodium soap in powder form, Gardolube® DP 9010 from Chemetall GmbH. This produced a 5.5 g/m² phosphate coating and an approximately 10 g/m² sodium stearate coating. The wire rod coated with this coating system was drawn six times in a multiple drawing die, so that the work was largely carried out under production conditions. Equally good drawing conditions and results were achieved overall for the coatings according to the invention in comparison to the prior art.

The drawing program provided for a drawing speed of 0.5 or 1 m/s for the phosphated and soaped wire sections. In comparative experiment 4 the coated 5.5 mm wire rod was drawn in a single draw to 4.8 mm with a 24% reduction in cross-section. In comparative experiment 5 the 5.5 mm wire rod was drawn in 6 draws to 4.8 mm, 4.2 mm, 3.7 mm, 3.2 mm, 2.9 mm and 2.5 mm. This corresponds to reductions in cross-section of approximately 24%, 24%, 23%, 22%, 21% and 21%.

The coefficient of friction was characterised using an RWMG 3031-C instrument from Verzinkerei Rentrup GmbH, with which the contact pressure and the torque between a correspondingly coated disc and an uncoated disc was measured and converted to give the coefficient of friction. The friction properties according to metallic substrate, surface condition and applied coating system could be tested using this instrument. Two specimens, the coefficient of friction between which is to be determined, are pressed together with an adjustable force. The two specimens are rotated in opposite directions about an axis in order to measure the necessary torque. The ratio between the defined contact pressure and the measured torque gives the coefficient of friction. The coefficient of friction characterises the friction and lubricating behaviour.

TABLE 3
Measured coating weights for the phosphate coating (SG) before and
after wire drawing (residual phosphate coat) and coefficients of
friction measured on the phosphate-coated specimens as compared
with single drawing and multiple drawing with conventional
single-layer zinc phosphate coatings produced without current

| | SG before | SG after | Coefficient of |
|---|---|---|---|
| Experiment no. | g/m² | g/m² | friction |
| Ca phosphating: 1 | 6.5 | 4.5 | 0.18 |
| Ca phosphating: 2 | 5.1 | 3.8 | 0.20 |
| Ca phosphating: 3 | 4.3 | 2.9 | 0.19 |
| Comparison: 4 - single | 5.5 | 4.0 | 0.19 |
| drawing with conventional | | | |
| currentless zinc phosphate | | | |
| coating | | | |
| Comparison: 5 - multiple | 5.5 | 1.1 | 0.19 |
| drawing with conventional | | | |
| currentless zinc phosphate | | | |
| coating | | | |

In all the cases according to the invention it was found that the coverage of the surface is adequate/good for a good separation of the die and wire. The coatings according to the invention thus proved to be of very high quality and also very suitable for high drawing speeds.

1-29. (canceled)

30. A process comprising preparing metallic workpieces for cold forming by bringing their metallic surfaces into contact with an aqueous acid phosphating solution to form at least one phosphate coating and then by coating the phosphate-coated surfaces with at least one lubricant to form at least one lubricating film, wherein, in addition to phosphate, the phosphating solution contains substantially only calcium, magnesium or/and manganese as cations chosen from cations from the 2^{nd} main group and the 1^{st}, 2^{nd} and 5^{th} to 8^{th} subgroups of the periodic table, that a phosphating solution containing alkaline-earth metals is free from fluoride and from complex fluoride, that the phosphating solution contains at least 5 g/l of compounds of calcium, magnesium or/and manganese including ions thereof, calculated as calcium, magnesium and manganese, and contains
a) 5 to 65 g/l of Ca and 0 to 20 g/l of Mg or/and Mn or
b) 5 to 50 g/l of Mg and 0 to 20 g/l of Ca or/and Mn or
c) 5 to 80 g/l of Mn and 0 to 20 g/l of Ca or/and Mg
and that phosphating is performed by electrolysis with a current density in the range from 5 to 200 A/dm², wherein a phosphate coating is formed with a coating weight in the range from 2 to 40 g/m².

31. The process according to claim 30, wherein the metallic workpieces in the phosphating solution are connected as the cathode and are treated with direct current or with a superposition of direct current and alternating current.

32. The process according to claim 30, wherein the metallic workpieces in the acid aqueous phosphating solution are not pickled or are almost not pickled.

33. The process according to claim 30, wherein before being phosphated, the metallic workpieces are pickled, degreased, cleaned, rinsed, mechanically scoured, ground, peeled, brushed, blasted or/and annealed.

34. The process according to claim 30, wherein the phosphating solution displays a phosphate content in the range from 2 to 500 g/l, calculated as PO₄.

35. The process according to claim 30, wherein the phosphating solution displays a content of alkali metals, including ammonium, in the range from 0.01 to 100 g/l.

36. The process according to claim 30, wherein the phosphating solution displays a content of at least one substance selected from organic acids, from phosphonic acids and the salts and esters thereof in the range from 0.1 to 200 g/l.

37. The process according to claim 30, wherein the phosphating solution displays a nitrate content in the range from 1 to 600 g/l.

38. The process according to claim 30, wherein as accelerator the phosphating solution contains at least one substance selected from substances based on chlorate, guanidine, hydroxylamine, nitrite, nitrobenzene sulfonate, perborate, peroxide,, peroxysulfuric acid and other accelerators containing nitro groups.

39. The process according to claim 30, wherein the phosphating solution displays a content of accelerators, excluding nitrate, in the range from 0.1 to 100 g/l.

40. The process according to claim 30, wherein the phosphating solution displays a content of compounds based on guanidine, such as e.g. nitroguanidine, in the range from 0.1 to 10 g/l, calculated as nitroguanidine.

41. The process according to claim 30, wherein a reducing agent which forms no poorly soluble compounds with calcium, magnesium or/and manganese in the pH range between 1 and 3 is added to the phosphating solution to influence the morphology of the phosphate coating.

42. The process according to claim 30, wherein the phosphating solution comprises:
0 to 40 g/l of alkali metal(s) or/and NH₄,
5 to 180 g/l of PO₄,
3 to 320 g/l of nitrate or/and accelerator(s) and
0 to 80 g/l of complexing agent(s).

43. The process according to claim 30, wherein the current density for electrolytic phosphating is in the range from 5 to 40 A/dm².

44. The process according to claim 30, wherein direct current or a superposition of direct current and alternating current is used for electrolytic phosphating.

45. The process according to claim 44, wherein a superposition of direct current and alternating current is used for electrolytic phosphating, wherein the ratio of direct current component to alternating current component is kept in the range from 20:1 to 1:10, relative to the components measured in A/dm².

46. The process according to claim 30, wherein at least one lubricant or at least one lubricant composition containing at least one lubricant is applied to the phosphated surfaces.

47. The process according to claim 46, wherein at least one lubricant or at least one lubricant composition having at least one substance selected from soaps, oils, organic polymers and waxes is applied.

48. The process according to claim 47, wherein at least one soap which optionally reacts chemically at least partly with the phosphate is applied as the lubricant.

49. The process according to claim 46, wherein the optionally at least partly chemically converted phosphate coating and the at least one optionally at least partly chemically converted lubricating film together have a coating weight in the range from 2 to 100 g/m².

50. The process according to claim 46, wherein the metallic workpieces coated in this way are cold-formed and optionally then annealed, ground, lapped, polished, cleaned, rinsed, coated with at least one metal, coated with at least one pretreatment or/and passivating composition, coated with at least one organic composition or processed to make a composite component.

51. The process according to claim 30, wherein at least one substantially organic coating is applied to the metallic workpieces coated in this way before or/and after at least one cold forming.

52. A metallic workpiece coated with at least one phosphate coating produced according to the process of claim 30.

53. A method comprising coldforming the metallic workpiece of claim 52.
